(19) United States
(12) Patent Application Publication
(10) Pub. No.: US 2025/0110643 A1
(43) Pub. Date: Apr. 3, 2025

(54) APPARATUSES AND METHODS FOR BOUNDED FAULT COMPLIANT METADATA STORAGE

(71) Applicant: MICRON TECHNOLOGY, INC., BOISE, ID (US)

(72) Inventor: Sujeet Ayyapureddi, Boise, ID (US)

(73) Assignee: MICRON TECHNOLOGY, INC., BOISE, ID (US)

(21) Appl. No.: 18/747,658

(22) Filed: Jun. 19, 2024

Related U.S. Application Data
(60) Provisional application No. 63/587,491, filed on Oct. 3, 2023.

(51) Int. Cl. G06F 3/06

(52) U.S. Cl. CPC G06F 3/061; G06F 3/0629; G06F 3/0683

(57) ABSTRACT

Apparatuses, systems, and methods for bounded fault compliant metadata storage. A memory module may be capable of repairing information along a portion of the data terminals of a memory device. To prevent errors in the metadata from propagating across more than the correctable portion, the metadata may be provided along a portion of the data terminals, while the data associated with that metadata is provided along more data terminals. For example, in a 9×2p2 module the data may use two terminals, while the metadata only uses one. In a 5×2p4 module, the metadata may use a pair of terminals, while the data uses four.

### CROSS REFERENCE TO RELATED APPLICATION(S)

This application claims the benefit under 35 U.S.C. § 119 of the earlier filing date of U.S. Provisional Application Ser. No. 63/587,491 filed Oct. 3, 2023 the entire contents of which is hereby incorporated by reference in its entirety for any purpose.

### BACKGROUND

This disclosure relates generally to semiconductor devices, and more specifically to semiconductor memory devices. In particular, the disclosure relates to volatile memory, such as dynamic random access memory (DRAM). Information may be stored on individual memory cells of the memory as a physical signal (e.g., a charge on a capacitive element). During an access operation, an access command may be received along with address information which specifies which memory cells should be accessed. Memory devices may be packaged together onto a module, and the module may have error correction capabilities for at least some of the information stored on the memory device.

There is a growing interest in enabling the memory to store information in the array which is associated with pieces of data. For example, error correction information and/or metadata may be stored in the array along with their associated data. Memory modules may be capable of correcting certain sets of information. There may be a need to ensure that when metadata is used, the metadata is stored in such a way that it remains compatible with the module's correction capabilities.

### BRIEF DESCRIPTION OF THE DRAWINGS

FIG. 1 is a block diagram of a memory system according to some embodiments of the present disclosure.

FIG. 2 is a block diagram of a semiconductor device according an embodiment of the disclosure.

FIG. 3 is a block diagram of a memory device according to some embodiments of the present disclosure.

FIG. 4 is a block diagram of data and metadata bursts in a 9×2p2 architecture with 2 bytes of metadata enabled according to some embodiments of the present disclosure.

FIG. 5 is a block diagram of a memory system with a 5×2p4 memory module according to some embodiments of the present disclosure.

FIG. 6 is a block diagram of data and metadata bursts in a 5×2p4 architecture with 2 bytes of metadata enabled according to some embodiments of the present disclosure.

FIG. 7 is a flow chart of a method according to some embodiments of the present disclosure.

### DETAILED DESCRIPTION

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Memory arrays may generally include a number of memory cells arranged at the intersection of word lines (rows) and bit lines/digit lines (columns). The columns may be grouped together into column planes, and a column select (CS) signal may be used to select a set of columns within each of the active column planes to provide data. When an access command is received, the memory may prefetch a codeword (e.g., a number of bits of data) along with one or more associated bits from the memory and either replace the prefetched data with new data (e.g., as part of a write operation) or provide the prefetched data off the memory device (e.g., as part of a read operation). Some memory modes may involve providing less than all of the prefetched data off the memory device. For example, in a conventional memory device, in certain modes half of the prefetched data may be provided off the device, and the remainder may ignored.

Memory devices may store additional information which is associated with each codeword. For example, the additional information may include parity bits which are used as part of an error correction scheme, metadata which includes information about the data codeword (or is a portion of information about a larger set of data which includes the codeword), or combinations thereof.

As used herein, the term data may represent any bits of information that the controller wishes to store and/or retrieve from the memory. The term metadata may represent any bits of information about the data which the controller writes to and/or receives from the memory. For example, the metadata may be information that the controller generates about the data, about how or where the data memory is stored in the memory, about how many errors have been detected in the data, etc. The data and the metadata together represent information written to the memory by a controller and then also read from the memory by the controller, with the data and metadata differing in content and how they are generated in that the metadata is based on information about the data. The term parity may represent any bits generated by an error correction circuit of the memory based on the data, metadata, or combinations thereof. The parity may generally stay within the memory. In some embodiments, the amount of data and/or metadata retrieved as part of a single access operation may represent a set of bits which are a fragment of a larger piece of information. For example, the metadata bits retrieved as part of a single access operation (e.g., 4 bits) may not have any meaning on their own, but may have meaning when combined with sets of metadata bits retrieved as part of other access operations (e.g., to other memory arrays and/or to the same array at different times).

Memory devices may be packaged together onto a memory module. The memory module may include a number of memory devices, each of which stores data, and one or more error correction memory devices, which may store information used to correct errors when data is read out from the memory. For example, each memory device may have a number of input/output (or DQ) terminals. Each DQ terminal may send or receive a burst of serial data from/to the associated memory. Some memory module architectures may use the error correction memory devices to be able to correct up to one DQ terminal (or one set of DQ terminals) worth of data.

Various faults may cause errors in the data stored in the memory. The module may use error correction to correct some amount of the data. Some memory architectures may be able to repair all of the data from a single memory device. However, some memory architectures may only be able to correct up to a portion of the data. These portions may be based on the data terminals that the data is sent and received along. For example, some memory modules may be able to repair the data along up to half of the data terminals (e.g., one of two terminals, two of four terminals, etc.). A fault may become uncorrectable if the error extends across more data terminals than can be repaired. Accordingly, there may be a need to ensure that the metadata is ‘bounded fault’ compliant, and that any error in the metadata remains in a correctable portion of the DQ terminals.

The present disclosure is drawn to apparatuses, systems, and methods for bounded fault compliant metadata storage. A memory receives data along multiple terminals. For example, a first portion of the data may be received along a first data terminal and a second portion of the data may be received along a second data terminal. The metadata associated with that data may be sent and received along either the first data terminal or the second data terminal, but not both. In this manner, if there is an error with the metadata, it may be confined to a single DQ terminal (or set of DQ terminals) and not propagate across other terminals (or sets of terminals).

In an example implementation, the memory module may use a 9×2p2 architecture. In other words, the memory may include 9 total memory devices (8 data devices and 1 error correction device) and each of the data devices may operation in a 2p2 architecture, where each memory includes two pseudo-channels, each of which uses two data (DQ) terminals. During an access operation, 64 bits of data may be sent or received, in a burst of 32 data bits along each of the two data terminals. The module may store 2 bytes of metadata, across 8 devices, and so each device may receive 2 bits. The module may be capable of correcting up to a single DQ terminals worth of error. A first DQ terminal receives a burst length of 34 bits, with 32 data bits and 2 metadata bits. A second DQ terminal also receives a burst length of 34 bits, with 32 data bits and 2 junk bits (which may be discarded or otherwise not received by the memory). The two metadata bits are associated with the data along both terminals.

In another example implementation, the memory module may use a 5×2p4 architecture. The module includes 5 total memory devices, 4 data devices and 1 error correction device. Each device operates in a 2p4 architecture, with two pseudo-channels each with 4 DQ terminals. The module may be able to correct up to two of the DQ terminals on one of the data devices. The module may have 2B of metadata enabled, or 4 bits per data memory device. During an example write operation, each memory receives 128 bits of data and 4 bits of metadata. The memory receives a burst length of 34 bits along each DQ terminal. Two of the DQ terminals receive 32 bits of data and 2 bits of metadata, and two receive 32 bits of data and two junk bits (which are not latched or are discarded). In this way, the metadata is received along a pair of DQ terminals, but not both pairs which allows for correction.

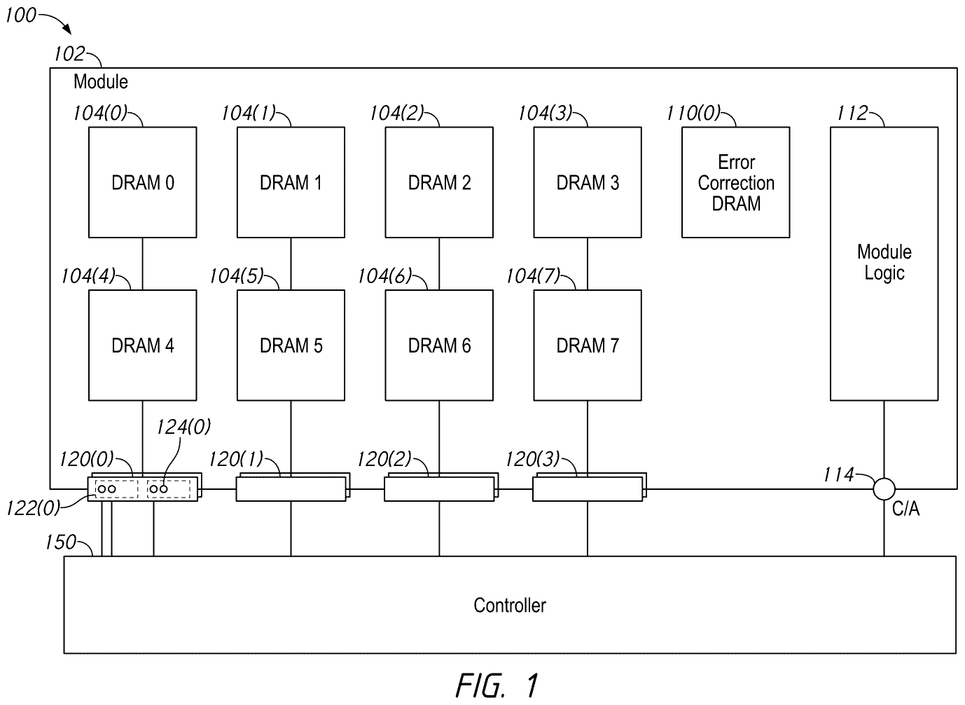

FIG. 1 is a block diagram of a memory system according to some embodiments of the present disclosure. The memory system 100 includes a memory module 102 and a controller 150 which operates the memory module 102. The module includes a number of memory devices 104 and 110. The memory devices 104 may be used to store data and may generally be referred to as data memory devices 104, while the memory device 110 is used to correct errors in data read from the data memory devices 104. The memory device 110 may be referred to as an error correction memory device 110. A module logic 112 receives commands and addresses over a command/address C/A bus from the controller 150 through a C/A terminal 114 and distributes those commands and addresses to the memory devices 104 and 110 over internal command and address buses (not shown). Data is communicated between the controller 150 and the module 102 along data buses which couple to data terminals (DQ) terminals 124 of the module 102. The data terminals 124 are organized into pseudo-channels 122 and channels 120. Each channel is a set of data terminals 124 associated with a memory device 104.

FIG. 1 shows an example 9×2p2 memory module 102 which may be used to implement some embodiments of the present disclosure. In the 9×2p2 architecture, there are nine total memory devices 104 and 110. Eight data memory devices 104(0) to 104(7) and one error correction memory device 110. Each channel 120(0) to 120(7) includes one or more pseudo-channels 122, which may be operated independently of each other. In this embodiment, each channel 120 includes two pseudo-channels 122, each of which includes two data terminals 124. Since the memory devices and channels may generally be similar to each other, only a single device 104(0) and its associate channel 120(0) are described in detail herein. In order to simplify the layout of the figure, an arrangement of two rows of four devices 104 each is shown, and their associated channels 120 are shown as stacked boxes. However the representation of FIG. 1 does not necessarily represent the layout of a physical device. For example, a single row of 8 devices 104 may be used. Similarly, various buses and signal lines have been simplified down to a single line for clarity on the drawing, however, multiple physical signal lines may be represented by a single line in the drawing.

During an example write operation, the controller 150 provides a write command and addresses (e.g., row, column, and/or bank addresses as explained in more detail herein) over the C/A terminal 114 to the module 102. The module logic 112 distributes the command and address to the data memory devices 104(0) to 104(7). The controller 150 also provides data to be written along the various DQ channels 120(0) to 120(7). Since the pseudo-channels 122 may be operated independently, we will consider a single pseudo-channel 122 and its two DQ terminals 124. Each data terminal receives a serial burst of bits, which together represent a codeword of data. For example, each terminal receives 32 data bits in series, for a total of 64 data bits per device and 512 bits of data per access operation across the module 102.

The controller 150 may also provide metadata bits. In the described embodiments, two bytes of metadata are provided, associated with the 512 data bits. These metadata bytes are distributed across the data devices 104 of the module. Since there are 8 total data devices 104, there are 2 bits of metadata for each device 104 along with the 64 data bits. A first DQ terminal 120 may receive 32 data bits and 2 metadata bits while a second DQ terminal 120 may receive 32 data bits (and 2 filler bits or other junk data which is discarded so that each terminal receives an equal burst length of 34 bits). The junk bits may represent a period where the controller 150 is not driving a particular voltage along the data terminal, where the controller is driving a set voltage (e.g., high or low) or other forms of not providing meaningful information. The memory devices 104 may ignore the junk data bits (e.g., by not latching them or by discarding them if latched). In some embodiments, the burst may be organized so that the data and metadata are sequential (e.g., 32 consecutive data bits and then 2 metadata bits). Other arrangements of the burst may be used in other example embodiments (e.g., metadata first, metadata interspersed among the data bits, etc.). The data is written to locations in the memory array specified by the address in the data memory devices 104.

During an example read operation, the controller 150 provides a read command and addresses along the C/A terminal 114. The module logic 112 distributes these to the memory devices 104 to 110 and data and metadata is read out from the locations specified by the addresses. Each DQ terminal 124 provides 32 bits of read data and either 2 bits of read metadata or two junk bits, for a total of 64 data bits per device 104 and 2 or 4 bits of metadata per device 104. The junk bits may represent a period where the memories 104 are not driving a particular voltage along the data terminal, where the memories are driving a set voltage (e.g., high or low) or other forms of not providing meaningful information. The controller 150 may ignore the junk data bits (e.g., by not latching them or by discarding them if latched).

The read and write operations may use a single-access pass to store both the data (as well as parity generated based on the data and metadata) along with the metadata bits. Each memory device may be capable of accessing up to 136 bits in a single access pass (e.g., generally 128 data bits and 8 parity bits). In the 9×2p2 architecture, 64 data bits plus 2 metadata bits are used (along with some number of parity bits, for example 8 parity bits). Accordingly, the data (plus parity) and metadata may all be accessed as a single access pass. For example, as explained in more detail herein, the memory array may be split into two portions, each of which is associated with a value of a column plane select bit in the column address. Data may be stored in the column planes of a selected one of the portions, while the metadata may be stored in one of the column planes of the non-selected portion. One or more bits of the column address may specify which portion of the column planes are selected and which column plan within the non-selected portion is used for the metadata bits.

During an example read operation, the error correction memory device 110 may be used to identify and correct errors in the data. The error correction memory device 110 may support correction of the data and metadata along one DQ terminal (e.g., the 34 bits provided along one of the terminals 124 in a pseudo-channel). The controller 150 may use information stored on the error correction memory device 110 to enable correction of the information after the information is received by the controller 150 during a read operation. For example, the error correction memory device 110 may store repair information (e.g., parity bits) which are associated with the data and metadata read out across all the data devices 104(0) to 104(3), and that parity may be used by a repair circuit (not shown) of the controller 150 to enable correction in the data and metadata of up to one of the DQ terminals. For example, if the data and metadata being provided along a first DQ terminal in a first pseudo-channel associated with memory 104(0) is corrupted, then the error correction device 110 enables the repair of that data and metadata. However, if the errors exist in bits across both DQ terminals in the pseudo-channel then correction may not be possible.

To prevent errors in the metadata from propagating across multiple DQ terminals, the metadata is sent and received along one, but not both, of the DQ terminals 124 in a pseudo-channel 122 during a given access operation. One or more bits of the column address may indicate which DQ terminal 124 is being used for metadata. The DQ terminal used for metadata may change between access operations.

In some embodiments, each memory device 104 may also have its own separate error correction, for example an error correction code (ECC) circuit which can repair one or more bits of error in the codeword. For example, each memory 104 may implement single error correction (SEC) and correct up to 1 bit of error in the 66 bits (64 data plus 2 metadata) read out as part of a read command. The ECC circuits in each of the memory devices 104 may generate parity bits when the data/metadata is written, and then may use those parity bits to detect and/or correct errors. The parity bits may generally stay within the devices 104, and not be read out to the controller 150.

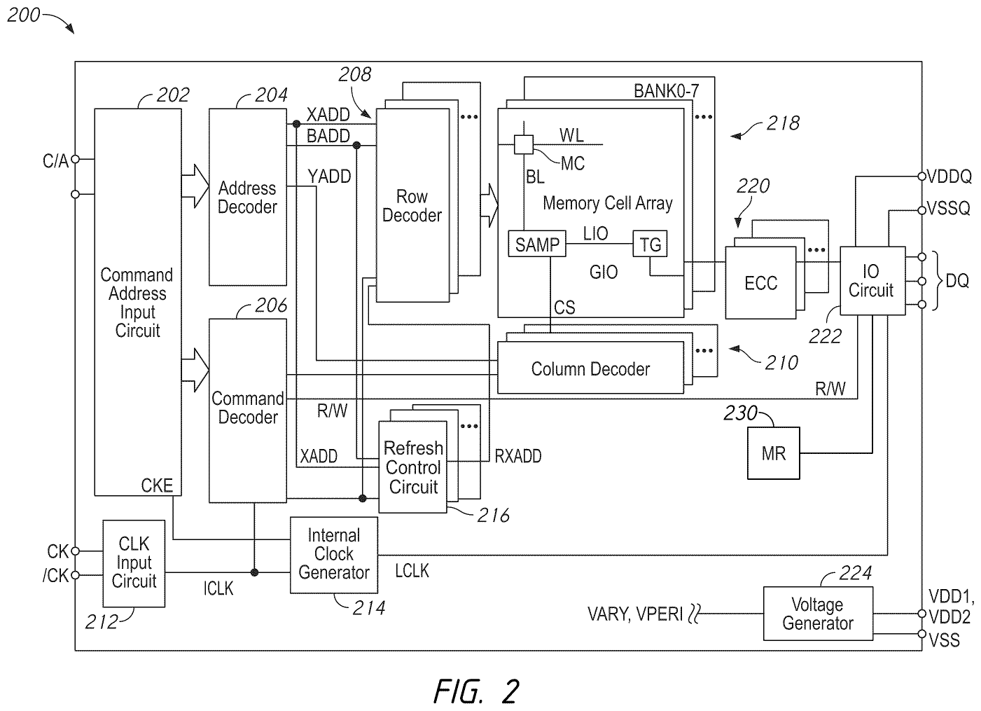

FIG. 2 is a block diagram of a semiconductor device according an embodiment of the disclosure. The semiconductor device 200 may be a semiconductor memory device, such as a DRAM device integrated on a single semiconductor chip. For example, the device 100 may implement one of the devices 204 of the module 202 of FIG. 2.

The semiconductor device 200 includes a memory array 218. The memory array 218 is shown as including a plurality of memory banks. In the embodiment of FIG. 2, the memory array 218 is shown as including eight memory banks BANK0-BANK7. More or fewer banks may be included in the memory array 218 of other embodiments.

Each memory bank includes a plurality of word lines WL, a plurality of bit lines BL, and a plurality of memory cells MC arranged at intersections of the plurality of word lines WL and the plurality of bit lines BL. The selection of the word line WL is performed by a row decoder 108 and the selection of the bit lines BL is performed by a column decoder 210. In the embodiment of FIG. 2, the row decoder 208 includes a respective row decoder for each memory bank and the column decoder 210 includes a respective column decoder for each memory bank.

The bit lines BL are coupled to a respective sense amplifier (SAMP). Read data from the bit line BL is amplified by the sense amplifier SAMP, and transferred to an ECC circuit 220 over local data lines (LIO), transfer gate (TG), and global data lines (GIO). Conversely, write data outputted from the ECC circuit 220 is transferred to the sense amplifier SAMP over the complementary main data lines GIO, the transfer gate TG, and the complementary local data lines LIO, and written in the memory cell MC coupled to the bit line BL.

The semiconductor device 200 may employ a plurality of external terminals, such as solder pads, that include command and address (C/A) terminals coupled to a command and address bus to receive commands and addresses, clock terminals to receive clocks CK and /CK, data terminals DQ coupled to a data bus to provide data, and power supply terminals to receive power supply potentials VDD, VSS, VDDQ, and VSSQ. The external terminals may couple directly to the controller (e.g., 150 of FIG. 1) and/or may couple to various buses/connectors of the module (e.g., 102 of FIG. 1).

The clock terminals are supplied with external clocks CK and /CK that are provided to an input circuit 212. The external clocks may be complementary. The input circuit 212 generates an internal clock ICLK based on the CK and /CK clocks. The ICLK clock is provided to the command decoder 206 and to an internal clock generator 214. The internal clock generator 214 provides various internal clocks LCLK based on the ICLK clock. The LCLK clocks may be used for timing operation of various internal circuits. The internal data clocks LCLK are provided to the input/output circuit 222 to time operation of circuits included in the input/output circuit 222, for example, to data receivers to time the receipt of write data. The input/output circuit 222 may include a number of interface connections, each of which may be couplable to one of the DQ pads (e.g., the solder pads which may act as external connections to the device 200).

The C/A terminals may be supplied with memory addresses. The memory addresses supplied to the C/A terminals are transferred, via a command/address input circuit 202, to an address decoder 204. The address decoder 204 receives the address and supplies a decoded row address XADD to the row decoder 208 and supplies a decoded column address YADD to the column decoder 210. The decoded row address XADD may be used to determine which row should be opened, which may cause the data along the bit lines to be read out along the bit lines. The column decoder 210 may provide a column select signal CS, which may be used to determine which sense amplifiers provide data to the LIO. The address decoder 204 may also supply a decoded bank address BADD, which may indicate the bank of the memory array 218 containing the decoded row address XADD and column address YADD.

The C/A terminals may be supplied with commands. Examples of commands include timing commands for controlling the timing of various operations, access commands for accessing the memory, such as read commands for performing read operations and write commands for performing write operations, as well as other commands and operations. The access commands may be associated with one or more row address XADD, column address YADD, and bank address BADD to indicate the memory cell(s) to be accessed.

The commands may be provided as internal command signals to a command decoder 106 via the command/address input circuit 202. The command decoder 206 includes circuits to decode the internal command signals to generate various internal signals and commands for performing operations. For example, the command decoder 206 may provide signals which indicate if data is to be read, written, etc.

The device 200 may receive an access command which is a write command. When the write command is received, and a bank address, a row address and a column address are timely supplied with the write command, write data and metadata supplied to the data terminals DQ by the controller is provided along the data bus and written to memory cells in the memory array 218 corresponding to the row address and column address. The write command is received by the command decoder 206, which provides internal commands so that the write data along with metadata is received by data receivers in the input/output circuit 222. The input/output circuit 122 may receive a signal which indicates which DQ circuit(s) are receiving metadata and which are receiving junk data. The write data is supplied via the input/output circuit 222 to the ECC circuit 220 along with the metadata. The junk data may be ignored or discarded by the IO circuit 122. The ECC circuit generates parity bits based on the received data and metadata and the ECC circuit 120 provides the data, metadata, and parity to the memory array 218 to be written along a word line specified by the row address to memory cells specified by the column address.

The device 200 may receive an access command which is a read command. When a read command is received, and a bank address, a row address and a column address are timely supplied with the read command, read data is read from memory cells in the memory array 218 corresponding to the row address and column address. The read command is received by the command decoder 206, which provides internal commands so that read data from the memory array 218 is provided to the ECC circuit 220. The ECC circuit 220 receives data bits, metadata bits, and parity bits from the array and detects and/or corrects errors in the data and metadata bits. The correct read data and metadata is provided along the data bus, and the data and metadata are output to outside from the data terminals DQ via the input/output circuit 222. The input/output circuit 222 may use one or more bits of the column address to determine which DQ terminal to provide the metadata along, and may provide junk data along the other DQ terminal (or do nothing with that terminal during those clock cycles, which may also serve as junk data).

The device 200 includes refresh control circuits 216 each associated with a bank of the memory array 218. Each refresh control circuit 216 may determine when to perform a refresh operation on the associated bank. The refresh control circuit 216 provides a refresh address RXADD (along with one or more refresh signals, not shown in FIG. 1). The row decoder 208 performs a refresh operation on one or more word lines associated with RXADD. The refresh control circuit 216 may perform multiple types of refresh operation, which may determine how the address RXADD is generated, as well as other details such as how many word lines are associated with the address RXADD.

The ECC circuit 220 may detect and/or correct errors in the accessed data. As part of a write operation, the ECC circuit 220 may receive bits from the IO circuit 222 and generate parity bits based on those received bits. The received bits and parity bits are written to the memory array 218. During an example read operation, the ECC circuit 220 receives a set of bits and their associated parity bits from the array 218 and uses them to locate and/or correct errors. For example, in a single error correction (SEC) scheme, up to one bit of error may be located and detected. In a single error correction double error detection (SECDED) scheme, up to one bit of error may be corrected, but two errors may be detected (although the bits causing those errors are not individually located, so no correction can be made). The ECC circuit 220 may correct the information and then provide the corrected information (and/or a signal indicated detected errors) to the IO circuit 222. The parity bits may generally not be provided to the IO circuit 222.

The mode register 230 may include various settings, and may be used to enable a metadata mode of the memory 200. When metadata is enabled, the device 200 may store metadata which is associated with the data. For example, as part of a write operation the controller may provide data along with its associated metadata, and as part of a read operation may receive data and its associated metadata.

The memory 200 may be operated in various modes based on a number of the DQ pads which are used. In some embodiments, the mode register 230 may include settings which determine how many DQ pads are used, even if there are more DQ pads available. The mode may determine both how many DQ pads the controller expects to send/receive data along, as well as the format and/or number of bits which the controller expects as part of a single access command. For example, the memory may have 16 physical DQ pads. In a 2p2 mode, four of those DQ pads are used, divided into two pseudo-channels of two DQ pads each. The mode may also determine a burst length at each DQ terminal as part of a DQ operation. The burst length represents a number of serial bits at each DQ terminal during an access operation. For example, in the 2p2 mode, each data terminal may receive a burst of 32 data bits plus some number of metadata bits. When two bytes of metadata are enabled, then the burst length may be 34 along each terminal.

The power supply terminals are supplied with power supply potentials VDD and VSS. The power supply potentials VDD and VSS are supplied to an internal voltage generator circuit 224. The internal voltage generator circuit 224 generates various internal potentials VARY, and the like based on the power supply potentials VDD and VSS supplied to the power supply terminals.

The power supply terminals are also supplied with power supply potentials VDDQ and VSSQ. The power supply potentials VDDQ and VSSQ are supplied to the input/output circuit 222. The power supply potentials VDDQ and VSSQ supplied to the power supply terminals may be the same potentials as the power supply potentials VDD and VSS supplied to the power supply terminals in an embodiment of the disclosure. The power supply potentials VDDQ and VSSQ supplied to the power supply terminals may be different potentials from the power supply potentials VDD and VSS supplied to the power supply terminals in another embodiment of the disclosure. The power supply potentials VDDQ and VSSQ supplied to the power supply terminals are used for the input/output circuit 122 so that power supply noise generated by the input/output circuit 122 does not propagate to the other circuit blocks.

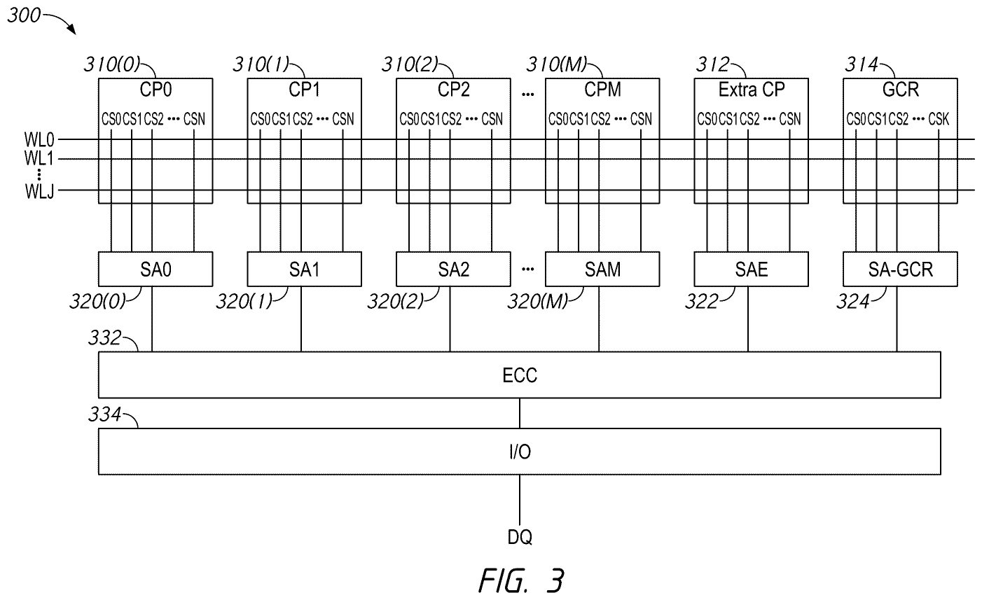

FIG. 3 is a block diagram of a memory device according to some embodiments of the present disclosure. The memory device 300 may, in some embodiments, represent a portion of the memory device 200 of FIG. 2. The view of FIG. 3 shows a portion of a memory array 310-314 and 320-324 which may be part of a memory bank (e.g., 218 of FIG. 2) along with selected circuits used in the data path such as the ECC circuit 332 (e.g., 220 of FIG. 2) and IO circuits 334 (e.g., 222 of FIG. 2). For clarity certain circuits and signals have been omitted from the view of FIG. 3.

The memory device 300 is organized into a number of column planes 310-314. Each of the column planes represents a portion of a memory bank. Each column plane 310-314 includes a number of memory cells at the intersection of word lines WL and bit lines. The bit lines may be grouped together into sets which are activated by a value of a column select (CS) signal. For the sake of clarity, only a single vertical line is used to represent the bit lines of each column select set, however, there may be multiple columns accessed by that value of CS. For example, each line may represent 8 bit lines, all accessed in common by a value of CS. As used herein, a ‘value’ of CS may refer to a decoded signal provided to sets of bit lines. So a first value may represent a first value of a multibit CS signal, or after decoding a signal line associated with that value being active. The word lines may be extend across multiple of the column planes 310-314.

The memory 300 includes a set of data column planes 310 as well as an extra column plane 312. The extra column plane 312 may be used to store additional information, such as error correction parity bits or metadata bits.

In some embodiments, the memory 300 may also include an optional global column redundancy (GCR) column plane 314. In some embodiments, the GCR plane 314 may have fewer memory cells (e.g., fewer column select groups) than the data column planes 310. The GCR CP 314 includes a number of redundant columns which may be used as part of a repair operation. If a value of the CS signal is identified as including defective memory cells in one of the data column planes 310, then the memory may be remapped such that the data which would have been stored in that column plane for that value of CS is instead stored in the GCR CP 314.

In an example embodiment, the memory 310 may include 16 data column planes 310(0)-310(15). Each of those data column planes 310 includes 64 sets of column selects activated by a value of the column select signal, and each set of column select includes 8 bit lines. Accordingly, when a word line is opened responsive to a row address, and a column select signal is provided to each of the 16 column planes then 8 bits are accessed from each of the 16 column planes for a total of 128 bits. A column select signal is also provided to the extra column plane 312, although that column select signal may be a different value than the one provided to the data column planes 310 for an additional 8 bits. If a repair has been performed, the GCR CP 314 may also be accessed and the value on a GCR LIO may be used while ignoring the LIO of the column plane it is replacing. Accordingly, the maximum number of bits that can be retrieved as part of an access pass is 128 bits from the data column planes 310 (with 8 bits substituted from the GCR CP 314 if there has been a repair) along with 8 additional bits from the extra CP 312.

In the 2p2 architecture, fewer than 128 bits of data are accessed for a given access operation. Accordingly, only a portion of the data column planes 310 may be used to send/receive data. The column address may include a column plane select bit or bits which are used to determine which portion of the data column planes 310 are used. For example, the data column planes 310 may be split into two sets of eight data column planes each. A bit of the column address (e.g., CA10) may be used as the column plane select bit and may choose which set of data column planes is being used as part of the current access operation.

Similarly, since the metadata is received along one DQ terminal, but not both, a different bit of the column address may be used as a terminal select bit. For example, if CA10 is used as CP select bit, then CA9 may be used as the terminal select bit. Based on the state of CA9, the metadata may be expected along a first DQ terminal (e.g., when CA9 is a logical low) or a second DQ terminal (e.g., when CA9 is a logical high). Similarly, the I/O circuit 234 may know to ignore or discard the junk data received along the non-selected terminal based on the state of the terminal select bit.

As described in more detail herein, during a given access operation, data may be stored in the portion of the column planes selected by the column plane select bit, while metadata (and in some cases parity) may be stored in one or more of the non-selected column planes. For example, the data may be stored in each column plane of the selected portion (e.g., 8 bits in each of 8 selected data column planes 310 for a total of 64 data bits). The metadata may be stored in one of the column planes in the non-selected portion. For example, if the column plane select bit selects even data column planes, then the metadata may be stored in one of the odd column planes. The terminal select bit (e.g., CA9) may be used to help select which of the odd column planes the metadata bits are stored in. In the example embodiment with 2 bytes of metadata enabled, the 2 bits of metadata may be stored in two memory cells in the chosen odd column plane.

In some embodiments of the 9×2p2 architecture of the present disclosure, the parity bits may be store either in the extra column plane 312 or in one of the non-selected column planes. In an example implementation, each set of 64 data bits may be associated with 8 bits of parity generated by the ECC circuit 332. However, the extra column plane 312 may not have space for all of the parity bits. Accordingly, some parity bits may be stored in the extra column plane 312 and some may be stored in the non-selected data column planes 310 similar to the metadata (although the metadata and parity may be stored in different non-selected column planes for a given set of data bits).

In an example write operation, a controller (e.g., 150 of FIG. 1) provides data and metadata to the memory device which are written as part of a single access pass. In the example embodiment discussed herein, 64 bits of data are provided along with 2 bits of metadata, such that each of the two DQ terminals per pseudo-channel receives a burst length of 34 (32 data bits and either 2 metadata bits or two junk bits). The data and metadata is provided to the ECC circuit 332 which generates a set of parity bits based on the data and metadata bits. For example 8 parity bits may be generated based on the 64 data bits and 2 metadata bits. Based on the column address half of the data column planes 310 may be selected and the column decoder may provide a first value of the CS signal to the selected half of the column planes and provide a second value of the CS signal to the non-selected half of the column planes.

The data may be written to the memory cells at the intersection of the active word line and the bit lines selected by the first value of CS in the selected half of the column planes 310. The metadata may be written to the memory cells at the intersection of the active word line and the bit lines selected by the second value of CS in a selected one of the non-selected half of the column planes. Which of the non-selected column planes 210 is used for storing the metadata may be based, in part, on the terminal select bit (e.g., CA9). For example, if the even column planes are selected, then metadata may be written to column planes 1 if CA9 is in a first state or column plane 5 is CA9 is in a second state (and the metadata was received along a different terminal). Depending on the column address, the parity bits may either be written to the memory cells at the intersection of the word line and the bit lines selected by a CS signal (which may be the first CS value or a different value) in the extra column plane 312, or they may be written to the memory cells at the intersection of the word line and the bit lines selected by a third value of the CS signal in one of the non-selected column planes.

In some embodiments, since 8 bit lines are activated by each CS value, and there are 2 metadata bits written, it may be useful to protect the remaining 6 bits associated with that value of CS in that column plane so they are not erroneously overwritten. In some embodiments, the memory may perform a read/modify/write cycle to read out all 8 bits, modify only the 2 which are being changed, and then write all 8 bits back. In some embodiments, separate write enable signals may be used such that only some of the sense amplifiers associated with the CS value are modified at one time (rather than all 8). For example, only the sense amplifiers associated with the 2 bitlines which will store the new metadata bits may be activated. This may prevent the data on the bit lines coupled to the non-related sense amplifiers from being modified without requiring additional operations (e.g., a read/modify/write cycle). Other options for protecting the non-accessed bits associated with the CS signal may be used in other example embodiments.

In an example read operation, the data, metadata, and parity are retrieved as part of a single access pass. For example, the second CS value is provided by the column decoder to the selected locations in the non-selected portion of the column planes 310 and the metadata is retrieved from the two locations it was saved in. Half the bits (e.g., 2 or 4 bits) are retrieved from one location and half the bits (e.g., 4 bits) are retrieved from the second location. As part of the same access, the column decoder provides the first CS signal to the selected portion of the column planes 310 and the data bits are read from the column planes 310. The parity is retrieved either from the extra column plane 312 based on the first CS signal, or from another one of the non-selected column planes based on the third CS signal value. The data (e.g., 64 bits), metadata (e.g. 2 bits) and parity (e.g., 8 bits) are provided to the ECC circuit 332 which performs error correction on the data and metadata based on the received bits. For example, the ECC circuit 332 may perform single error correction (SEC) where up to one bit of error in the data and metadata is located and corrected. Other types of error correction such as single error correction, double error detection (SECDED) may also be used. The corrected data bits and the corrected metadata (e.g., 2 bits) are provided to the I/O circuit 334, where they provided to the DQ terminals.

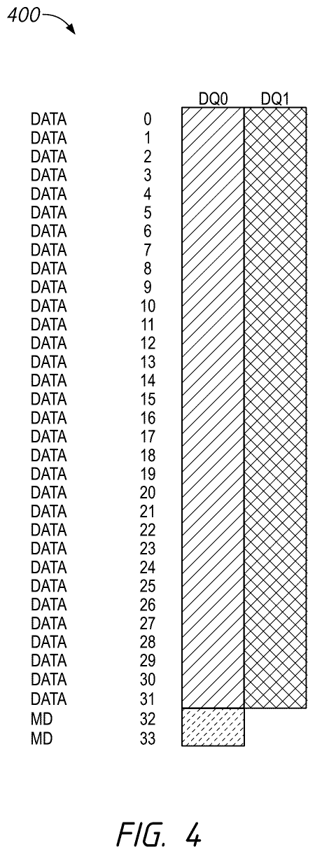

FIG. 4 is a block diagram of data and metadata bursts in a 9×2p2 architecture with 2 bytes of metadata enabled according to some embodiments of the present disclosure. The diagram 400 of FIG. 4 represents how data and metadata may be sent and received across multiple terminals. For example, the diagram 400 may represent how data and metadata are sent and received across DQ terminals such as the DQ terminals 124 of FIG. 1.

The diagrams show two data terminals, DQ0 and DQ1, as well as the bits sent/received as part of a burst length during an access operation. Each bit in the burst length may be synchronized with a rising or falling edge of a read or write clock. In the embodiment shown in FIG. 4, the burst length includes the data in a sequential block, followed by the metadata. Each terminal DQ0 and DQ1 receives a burst of 32 bits of data (e.g., DATA 0 to DATA 31). One of the two terminals also receives two bits of metadata. In the example of FIG. 4, the first DQ terminal (DQ0) is selected. The DQ terminal which has metadata may be chosen based on a terminal select bit of the column address (e.g., CA9). If the terminal select bit had the other state, then the metadata would be received along the other DQ terminal (DQ1).

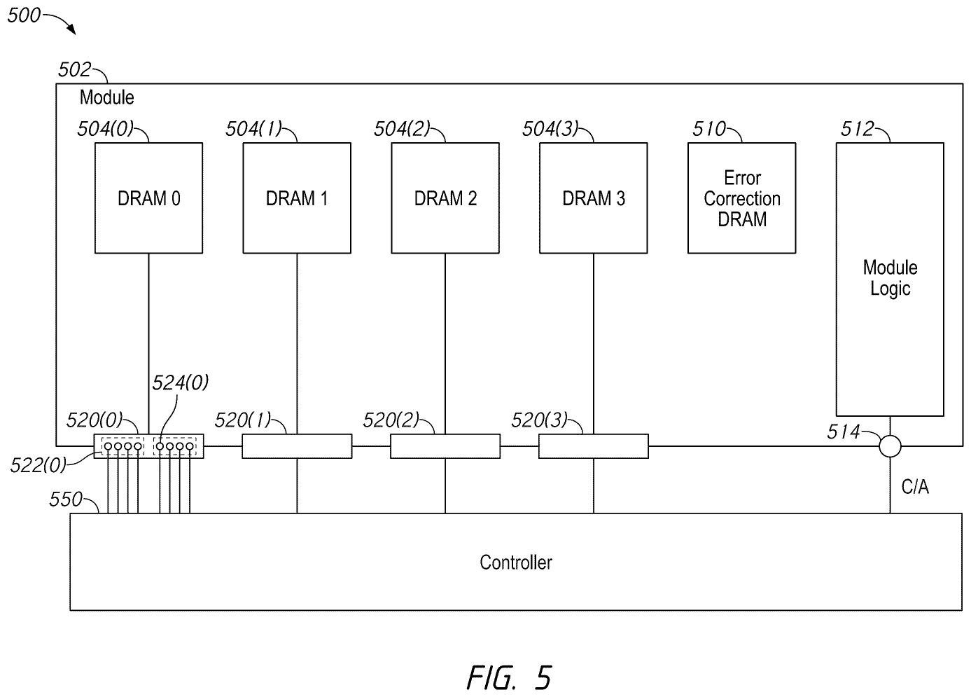

FIG. 5 is a block diagram of a memory system with a 5×2p4 memory module according to some embodiments of the present disclosure. The memory system 500 of FIG. 5 may be broadly similar to the memory system 100 of FIG. 1, except that the memory system 500 of FIG. 5 is configured in a 5×2p4 format rather than a 9×2p2 format. Since many of the features, components, and operations may be similar, for the sake of brevity, details which were already explained with respect to the memory system 100 of FIG. 1 will generally not be repeated with respect to the memory system 500 of FIG. 5.

The memory module 502 includes a number of memory devices 504 to 510. A controller 550 operates the memory module 502 by providing commands and addresses along a C/A bus through a C/A terminal 514 and module logic 512 distributes the commands and addresses to one or more of the memory devices 504/510. Each of the memory devices 504 and/or 510 may be implemented by the memory device 200 of FIGS. 2 and/or 300 of FIG. 3 in some embodiments. The module 502 also includes a number of channels 520, each of which includes two pseudo-channels 522, each with a number of DQ terminals 524.

Unlike the memory system 100 of FIG. 1, in the 5×2p4 module 502, there are five total memory devices, four data devices 504 and one error correction device 510. Each channel 520 includes two pseudo-channels 522, each of which includes four DQ terminals 524. During a given access operation, the error correction device 510 may be able to correct up to the bits along two of the DQ terminals in a pseudo-channel.

During an example access operation, each DQ terminal 524 may send/receive 32 data bits for a total of 128 data bits for each memory device 504. When two bytes of metadata are enabled across the module 502, each data device 504 stores 4 bits of metadata. Accordingly, to keep the module 502 bounded fault compliant, during an access operation, the DQ terminals 524 may carry a burst length of 34 bits, with two of the DQ terminals sending/receiving 32 data bits and 2 DQ bits, and two of the DQ terminals sending/receiving 32 data bits and 2 junk bits. In this way, the metadata may be carried along one pair of the DQ terminals, but not the other, which may allow for correction if there is a fault which effects the metadata.

During an example write operation in the 5×2p4 module 500, each data device 504 may receive 128 data bits, along with 4 metadata bits. Each memory device 504 may generate 8 parity bits based on the 128 data bits and 4 metadata bits, for a total of 140 bits. However, referring back to the memory device 300 of FIG. 3, each memory device 504 may include 16 column planes plus an extra column plane for parity, each of which can store up to 8 bits per access operation. Since more bits are stored per access operation in the 5×2p4 module, a two-pass architecture may be used. For case of explanation, reference will be made to the reference numbers and components of FIG. 3 to describe the two-pass architecture.

During an example write operation, the IO circuit 334 receives 128 data bits, 32 along each of four DQ terminals, and 4 bits of metadata divided into two bits along one pair of the DQ terminals. The ECC circuit 332 receives the data and the metadata and generates 8 parity bits based on the data and the metadata. The metadata may be stored (e.g., in a latch).

During a first access pass, the column decoder generates a CS signal with a value based on the column address, and the data is written to memory cells in the data column planes 310 at the intersection of the bit lines activated by the value of CS (e.g., 8 memory cells in each data column plane 310) and an active word line (activated by the row decoder responsive to the row address). The parity bits are written to the memory cells at the intersection of the active word line and bit lines selected by a CS signal in the extra column plane 312. The CS signal used for the extra column plane 312 may have a same or different value than the CS signal used for the data column planes 310. In some embodiments, the same decoded CS signal may be provided in common to the data and extra column planes 310 and 312.

As part of a second access pass, the metadata bits which were stored are written to one of the data column planes 310. The column decoder generates a CS signal with a value and provides it to one of the column planes 310. The metadata bits are written to memory cells at the intersection of the word line (e.g., the same word line used in the first access pass) and bit lines activated by the CS value. The CS value for the second access pass may be different than the CS value(s) used for the first access pass. The CS value used for the second pass may also be based on the column address, based on internal mapping used by the column decoder to determine where the metadata bits should be stored for a given column address.

In some embodiments, since 8 bit lines are activated by each CS value, and there are 4 metadata bits written, it may be useful to protect the remaining 4 bits associated with that value of CS in that column plane so they are not erroneously overwritten. In some embodiments, the memory may perform a read/modify/write cycle to read out all 8 bits, modify only the 4 which are being changed, and then write all 8 bits back. In some embodiments, separate write enable signals may be used such that only some of the sense amplifiers associated with the CS value are modified at one time (rather than all 8). For example, only the sense amplifiers associated with the 4 bitlines which will store the new metadata bits may be activated. In some example embodiments, a first write enable signal maybe used for even bit lines and a second write enable signal may be used for odd bit lines. The even bit lines may be coupled to sense amplifiers positioned in a first gap (e.g., on one side of the memory cells) while the odd bit lines are coupled to sense amplifies positioned in a second gap (e.g., on an opposite side of the memory cells). The use of separate write enable signals may prevent the data on the bit lines coupled to the non-related sense amplifiers from being modified without requiring additional operations (e.g., a read/modify/write cycle). Other options for protecting the non-accessed bits associated with the CS signal may be used in other example embodiments.

In an example read operation, the memory may perform a two-pass operation to read out the data and metadata. As part of a first access pass, the word line is activated by the row decoder based on the row address, and the metadata is read out from the column plane 310 where it was stored based on a CS value provided by the column decoder responsive to the column address. The read metadata may be stored. During a second access pass, the data and parity bits are read out from memory cells along the active word line based on a CS signal(s) (e.g., similar to the CS signal or signals used in the first access pass during the write operation). The data, metadata, and parity are provided to the ECC circuit 332, which locates and/or corrects errors in the data and metadata. The corrected data and metadata are provided to the IO circuit 334, which provides the data in bursts along all four DQ terminals, and the metadata along a selected pair of the DQ terminals.

The memory module 502 receives the metadata along either a first pair of DQ terminals or a second pair of DQ terminals (e.g., either DQ0 and DQ1 or DQ2 and DQ3). During a write operation, a bit of the column address, such as a terminal select bit (e.g., CA9) may be used to indicate which pair of terminals receive metadata and which pair of terminals receive junk bits during the clock cycles when the metadata is received. Similarly, during a read operation, a bit of the column address, such as the terminal select bit may be used to indicate which pair of terminals the IO circuit should provide the metadata along. The terminal select bit may also be used, in part, to help select which column plane to store the metadata in.

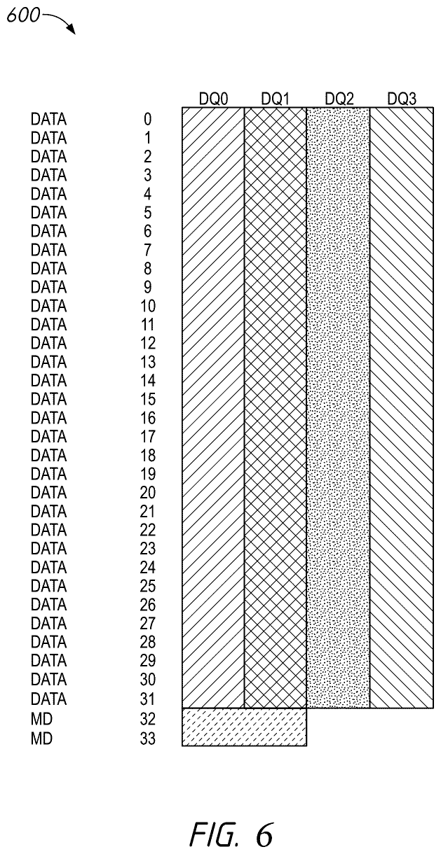

FIG. 6 is a block diagram of data and metadata bursts in a 5×2p4 architecture with 2 bytes of metadata enabled according to some embodiments of the present disclosure. The diagram 600 of FIG. 6 represents how data and metadata may be sent and received across multiple terminals. For example, the diagram 600 may represent how data and metadata are sent and received across DQ terminals such as the DQ terminals 514 of FIG. 5. The diagram 600 may generally be similar to the diagram 400 of FIG. 4, except for a 5×2p4 architecture instead of a 9×2p2 architecture.

The diagrams show four data terminals, DQ0 to DQ3, as well as the bits sent/received as part of a burst length during an access operation. Each bit in the burst length may be synchronized with a rising or falling edge of a read or write clock. In the embodiment shown in FIG. 6, the burst length includes the data in a sequential block, followed by the metadata. Each terminal DQ0 and DQ1 receives a burst of 32 bits of data (e.g., DATA 0 to DATA 31). One pair of the four terminals also receives two bits of metadata. In the example of FIG. 6, the first two DQ terminals (DQ0 and DQ1) are selected. The DQ terminals which have metadata may be chosen based on a terminal select bit of the column address (e.g., CA9). If the terminal select bit had the other state, then the metadata would be received along the other DQ terminals (DQ2 and DQ3). Other arrangements of pairs of DQ terminals (e.g., DQ0 and DQ2 or DQ1 and DQ3) may be used in other example embodiments.

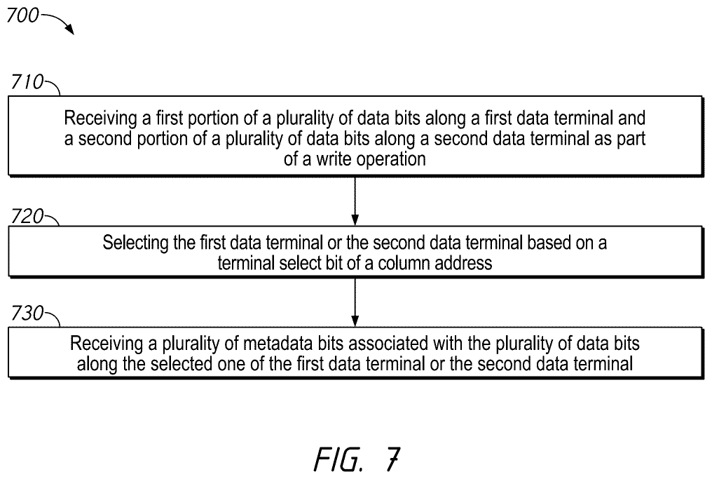

FIG. 7 is a flow chart of a method according to some embodiments of the present disclosure. The method 700 may, in some embodiments, be implemented by one or more of the apparatuses or systems described herein, such as the memory systems 100 of FIGS. 1 and/or 500 of FIG. 5 and/or the memory devices 200 and/or 300 of FIGS. 2-3.

The method 700 may generally begin with box 710, which describes receiving a first portion of a plurality of data bits along a first data terminal and a second portion of a plurality of data bits along a second data terminal as part of a write operation. For example, the data bits and meta data bits may be received from a controller such as 150 of FIGS. 1 and/or 550 of FIG. 5.

Box 710 may generally be followed by box 720, which describes selecting the first data terminal or the second data terminal based on a terminal select bit of a column address. For example, terminal select bit of the column address (e.g., CA9) may be used by a column decoder and/or an input/output circuit (e.g., 222 of FIGS. 2 and/or 334 of FIG. 3).

Box 720 may generally be followed by box 730, which describes receiving a plurality of metadata bits associated with the plurality of data bits along the selected one of the first data terminal or the second data terminal. The non-selected terminal may receive junk data while the metadata bits are being received. The data and metadata may be received as part of a burst of data and metadata along the terminal, such as the ones shown in FIGS. 4 and 6.

In some embodiments, the device may be part of a 9×2p2 memory module, and the method 700 may include writing the plurality of data bits and the plurality of metadata bits to a memory array as part of a single access pass. For example the method 700 may include selecting a first portion of a plurality of column planes or a second portion of the plurality of column planes of the memory array based on a column plane select bit of the column address, writing the plurality of data bits to the selected one of the first portion or the second portion of the plurality of column planes, and writing the plurality of metadata bits to a non-selected one of the first portion or the second portion of the plurality of column planes.

In some embodiments, the device may be part of a 5×2p4 memory module, and the method 700 may include writing the plurality of data bits to a memory array as part of a first access pass and writing the plurality of metadata bits to the memory array as part of a second access pass. The method 700 may also include receiving the data and metadata along additional terminals. For example, receiving a third portion of the plurality of data bits along a third data terminal and a fourth portion of the plurality of data bits along a fourth terminal as part of the write operation, selecting the third data terminal or the fourth data terminal based on the terminal select bit of the column address, and receiving a first portion of the plurality of metadata bits along the selected one of the first data terminal or the second data terminal and a second portion of the plurality of metadata bits along the selected one of the third data terminal or the fourth data terminal.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above-discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. An apparatus comprising:
a first data terminal configured to receive a first portion of a plurality of data bits as part of a write operation;
a second data terminal configured to receive a second portion of the plurality of data bits as part of the write operation; and
an input/output circuit configured to select the first data terminal or the second data terminal to receive a plurality of metadata bits associated with the plurality of data bits as part of the write operation.

2. The apparatus of claim 1, wherein the input/output circuit is configured to select the first data terminal or the second data terminal based on a state of a terminal select bit in a column address.

3. The apparatus of claim 1, wherein the first data terminal and the second data terminal are each configured to receive a burst length of 32 bits of data and the selected one of the first or the second data terminal is configured to receive 2 bits of metadata.

4. The apparatus of claim 1, further comprising:
a third data terminal configured to receive a third portion of the plurality of data bits as part of the write operation; and
a fourth data terminal configured to receive a fourth portion of the plurality of data bits as part of the write operation,
wherein the input/output circuit is configured to select the third data terminal or the fourth data terminal to receive a second portion of the plurality of metadata bits as part of the write operation.

5. The apparatus of claim 1, further comprising an error correction code (ECC) circuit configured to generate parity bits based on the plurality of data bits and the plurality of metadata bits.

6. The apparatus of claim 1, further comprising a memory array including a plurality of column planes, wherein the plurality of data bits and the plurality of metadata bits are written to the memory array as part of the write operation.

7. The apparatus of claim 6, further comprising a column decoder configured to write the data bits to a selected portion of the plurality of column planes and the plurality of metadata to one of a non-selected portion of the plurality of column planes as part of a single access pass.

8. The apparatus of claim 6, further comprising a column decoder configured to write the plurality of data bits to the plurality of column planes as part of a first access pass and configured to write the plurality of metadata bits to a selected one of the plurality of column planes as part of a second access pass as part of the write operation.

9. A system comprising
a memory device comprising a first data terminal and a second data terminal; and
a controller configured to provide a first portion of a plurality of data bits to the first data terminal and a second portion of the plurality of data bits to the second data terminal and further configured to provide a plurality of metadata bits associated with the plurality of data bits to one of the first or the second data terminals.

10. The system of claim 9, wherein the memory device is part of a 9×2p2 memory module.

11. The system of claim 10, wherein the memory device is configured to write the plurality of data bits to a memory array in a first access pass and to write the plurality of metadata bits to the memory array in a second access pass.

12. The system of claim 9 wherein the memory device is part of a 5×2p4 memory module.

13. The system of claim 9, wherein the memory device comprises an error correction code (ECC) circuit configured to generate parity based on the plurality of data bits and the plurality of metadata bits.

14. The system of claim 9, wherein the controller is configured to provide a column address with a terminal select bit which indicates which of the first or the second data terminals the controller is providing the plurality of metadata bits to.

15. A method comprising:
receiving a first portion of a plurality of data bits along a first data terminal and a second portion of a plurality of data bits along a second data terminal as part of a write operation;
selecting the first data terminal or the second data terminal based on a terminal select bit of a column address; and
receiving a plurality of metadata bits associated with the plurality of data bits along the selected one of the first data terminal or the second data terminal.

16. The method of claim 15, further comprising:
receiving a third portion of the plurality of data bits along a third data terminal and a fourth portion of the plurality of data bits along a fourth terminal as part of the write operation;
selecting the third data terminal or the fourth data terminal based on the terminal select bit of the column address; and
receiving a first portion of the plurality of metadata bits along the selected one of the first data terminal or the second data terminal and a second portion of the plurality of metadata bits along the selected one of the third data terminal or the fourth data terminal.

17. The method of claim 15, further comprising:
writing the plurality of data bits and the plurality of metadata bits to a memory array as part of a single access pass.

18. The method of claim 17, further comprising:
selecting a first portion of a plurality of column planes or a second portion of the plurality of column planes of the memory array based on a column plane select bit of the column address;
writing the plurality of data bits to the selected one of the first portion or the second portion of the plurality of column planes; and
writing the plurality of metadata bits to a non-selected one of the first portion or the second portion of the plurality of column planes.

19. The method of claim 15, further comprising:
writing the plurality of data bits to a memory array as part of a first access pass; and
writing the plurality of metadata bits to the memory array as part of a second access pass.

20. The method of claim 15, further comprising receiving the plurality of metadata bits as part of a burst length with the first or the second portion of the plurality of data bits.
